(19) United States
(12) Patent Application Publication
(10) Pub. No.: US 2007/0028063 A1
(43) Pub. Date: Feb. 1, 2007

(54) Device for restoring at least one of files, directories and application oriented files in a computer to a previous state

(75) Inventors: Alexander Hars, Goteborg (SE); Lars Karlsson, Gotoborg (SE)

Correspondence Address: DICKSTEIN SHAPIRO LLP, 1825 EYE STREET NW, Washington, DC, 20006-5403, US

(73) Assignee: SYSTEMOK AB, Goteborg (SE)

(21) Appl. No.: 10/547,313

(22) PCT Filed: Mar. 25, 2004
(86) PCT No.: PCT/SE04/00453

§ 371 Date: Sep. 27, 2006

(30) Foreign Application Priority Data
Mar. 26, 2003 (SE) 0300833-1

(51) Int. Cl. G06F 12/16

(52) U.S. Cl. 711/162

(57) ABSTRACT

A device (1) for restoring items such as files, directories and application-oriented files in a computer to a previous state is disclosed. The device comprises a processor (3), a memory (5), input/output means (7). The memory (5) comprises a storage area (9), backup area (11), an attribute area (13), an activity log file (15), and a state content area (17). The backup area (11) comprises originals of the items. The storage area (9), comprises changes to items. The attribute area (13) comprises copies of attributes to files and directories. The activity log file (15) comprises events that have occurred after the time of the previous state. The state content area (17) comprises content in relation to items at the time corresponding to the previous state. The device (1) is configured for managing the process of the restoring.

### TECHNICAL FIELD

The present invention relates to a device for restoring at least one of files, directories and application-oriented files in a computer to a previous state.

### BACKGROUND OF INVENTION

Companies today depend more and more on their computers, both as a working tool for the personnel and for managing and storing data. Computers have become an integral part of most business operations, and when a computer ceases to function, these business operations often cannot be conducted.

Common mistakes like unintentional file deletion, problems with corrupt software, system crashes, etc, have a great impact on companies. Not only do non-functional computers mean reduced productivity and frustrated end users, but they also lead to enormous costs. The fact that backup and recovery processes are time consuming is a major contributor to the high costs.

Over time, IT departments have deployed effective software solutions for protecting centralized data on servers, including backup and disaster recovery. Achieving the same level of protection on end user workstations is difficult.

Traditional backup solutions, which are often used to protect workstations as well as servers, are not designed with the single workstation in mind. Therefore, they have several disadvantages:

The backup process is time-consuming

In addition, the backup process is a single task procedure, preventing the user from using the workstation during this time.

The reconstruction process is time-consuming

From the user's perspective, the data recovery time means lost productivity.

Information is lost during the restore process

Documents and files created between the last backup and the crash will be lost during a restore process.

The backup and reconstruction process is highly advanced

This means that end users cannot solve computer issues themselves, but instead they have to wait for a busy technician to perform the reconstruction.

The most obvious shortcomings of a traditional backup solution are the lack of speed and its inability to protect user information. According to CBL (CBL Data Recovery Technologies Inc. “Data Loss Report”, 2002) more than 80% of their customers are unable to recover data, despite the use of a backup and storage system.

The importance of fast and simple recovery of a computer after a crash or an improper user action, for instance caused by a user having changed system settings, is highly relevant in order to reduce crash related costs.

### SUMMARY OF INVENTION

The present invention relates to a device for restoring at least one of files, directories and application-oriented files in a computer to a previous state. The device comprises a processor, a memory, input/output means. The memory comprises a storage area, backup area, an attribute area, an activity log file, and a state content area. The backup area is arranged to comprise originals of the at least one of files and directories. The storage area is arranged to comprise 1) changes to application oriented files, leaving original application oriented files unaltered, 2) copies of files and directories provided that there has been at least one alteration of the files and directories after the time of the previous state. The attribute area is arranged to comprise copies of attributes to files and directories, if there has been at least one alteration of the attributes to files and directories after the time of the previous state. The activity log file is arranged to comprise events related to the computer that have occurred after the time of the previous state. The state content area is arranged to comprise content in relation to files and directories at the time corresponding to the previous state.

The device is configured for
receiving from a user, using the input/output means, an instruction to restore the computer to the previous state;
investigating at least one of:
   the content of the backup area and attribute area for alterations; and
   the content of the activity log file for occurred events;
restoring the at least one of files, directories in the computer to the previous state by restoring the state according to the content of the state content area, and then processing at least one of one or more of the events in the activity log file; and one or more of the files in the backup area and the attribute area.

The present invention offers advantages such as it is fast, highly flexible to uses and easy and fast to install.

According to an embodiment, the activity log file is arranged for comprising at least two types of activities: new files/directories and renamed files/directories. This offers the advantage of being able to restore previous, stored, states of the computer.

According to an embodiment, the state content area is arranged to comprise a number of states available for a user, using the input/output means, to select a state. This offers the advantage of being of utility since a user may choose among a number of states. This leads to a user being able to investigate what state that is preferred by the user to restore.

According to an embodiment, the processor is further configured for moving the content of the backup area, the attribute area, the state content area, and the activity log file to a history area. This offers an opportunity of being able to divide the states into two categories; relevant ones and less relevant ones. Thus, a user may consider a number of states less relevant and is consequently less interested in having an opportunity of selecting among those.

According to an embodiment, the processor is further configured for allowing a user to select and recreate one of a number of states of the at least one of files and directories.

According to an embodiment, the processor is further configured for creating a state of the computer, the creating having been initiated by one of the user, a system event, such as an event related to an installation procedure, and according to a predetermined schedule, such as daily, weekly, or monthly.

According to an embodiment, the memory is further configured for comprising a translation list keeping track of information in the backup area, the attribute area, and the activity log file. This offers the advantage of a faster operation of the invention.

According to an embodiment, the memory comprising the translation list is constituted by the RAM memory. This offers the advantage of an even faster operation of the invention.

According to an embodiment, the processor is further configured for allowing a user to exclude at least one of files, directories and application oriented files from being processed by the device. This offers the advantage of states to which it is not fully possible to restore.

### BRIEF DESCRIPTIONS OF THE DRAWINGS

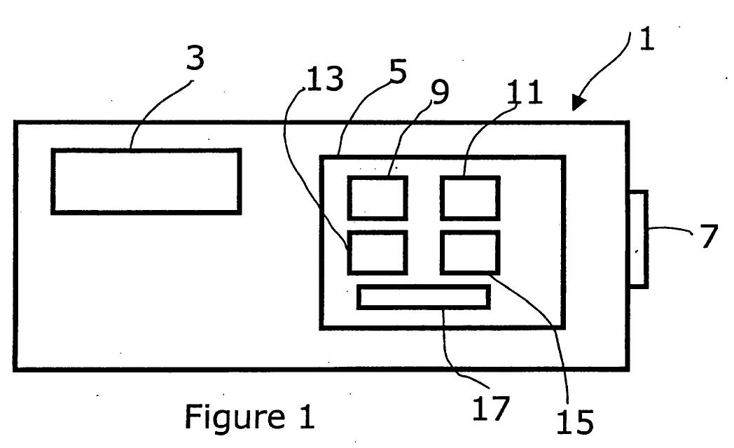

In FIG. 1, a schematic representation of the device for restoring at least one of files, directories and application-oriented files in a computer to a previous state is presented.

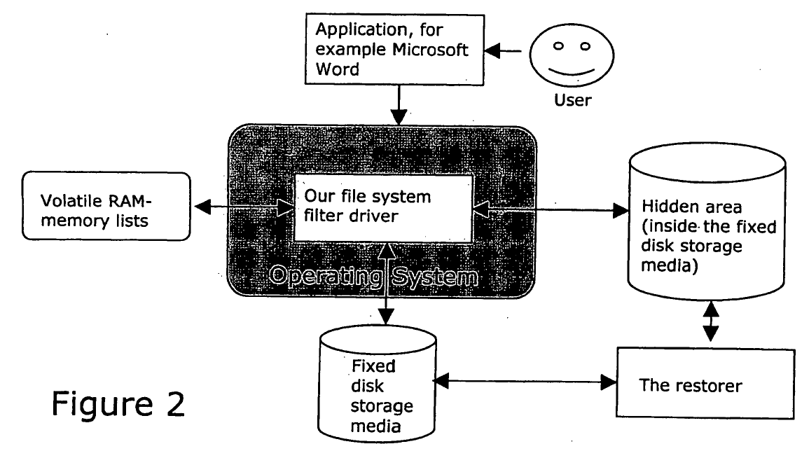

In FIG. 2, an overview of the inventive system to handle recoverable information is disclosed.

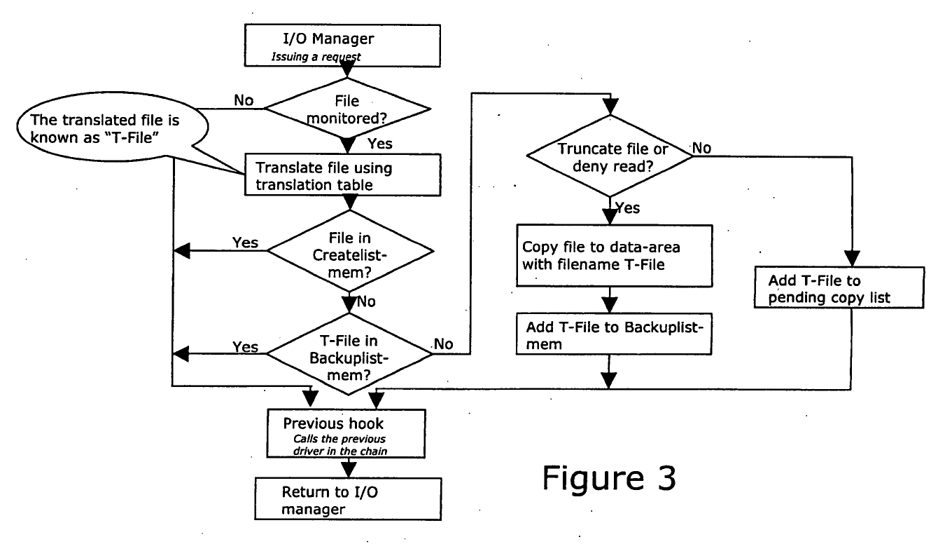

In FIG. 3, an embodiment of the logic for opening an existing file (with or without truncation of file) is presented.

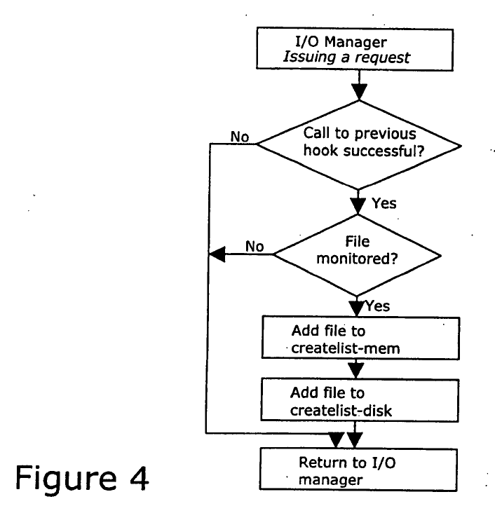

In FIG. 4, an embodiment of the logic for creating a new file/folder is presented.

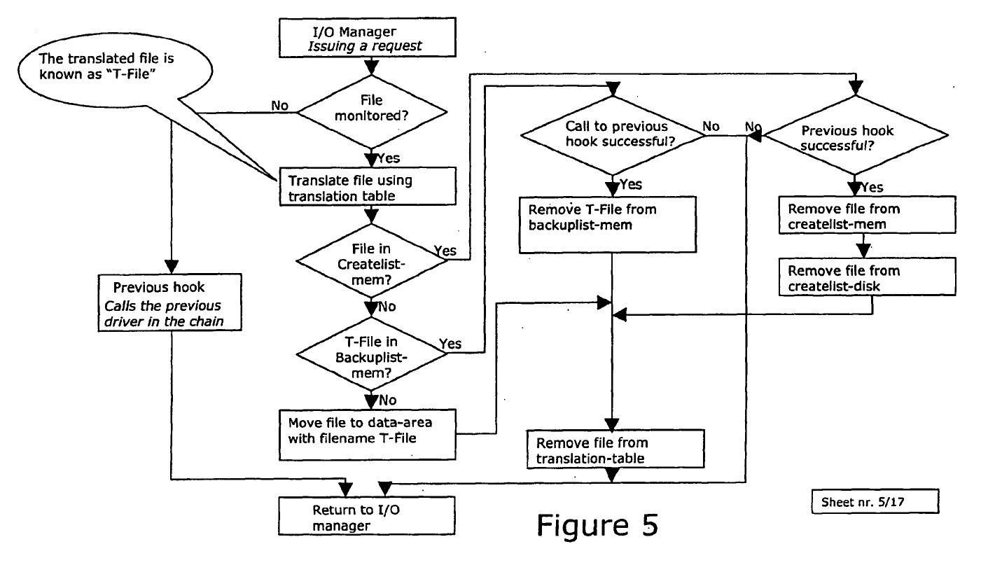

In FIG. 5, an embodiment of the logic for removing an existing file/folder is presented.

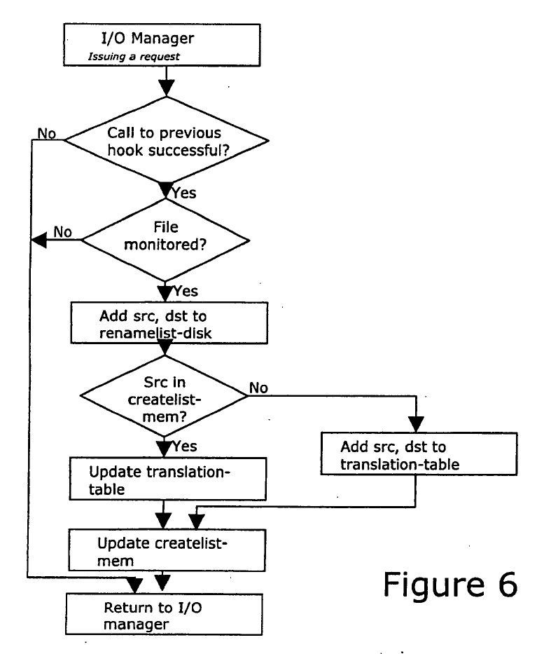

In FIG. 6, an embodiment of the logic for renaming/moving an existing file/folder is presented.

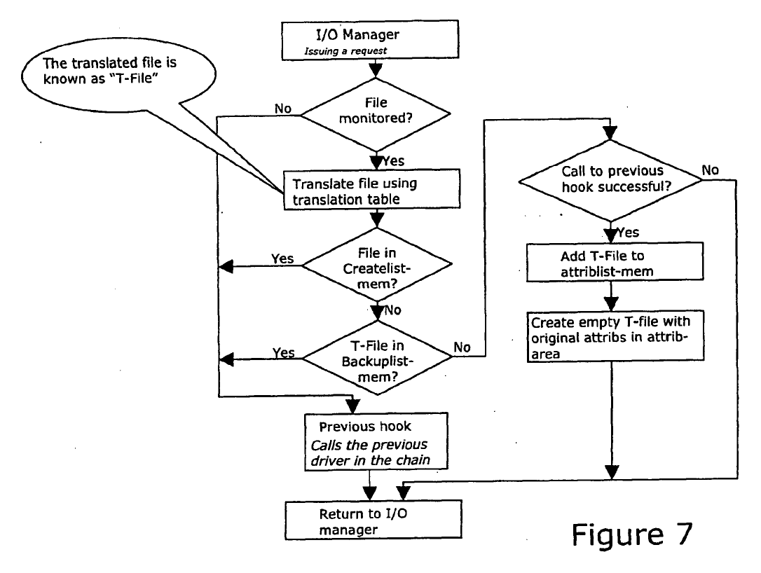

In FIG. 7, an embodiment of the logic for changing attributes/security settings for existing file/folder is presented.

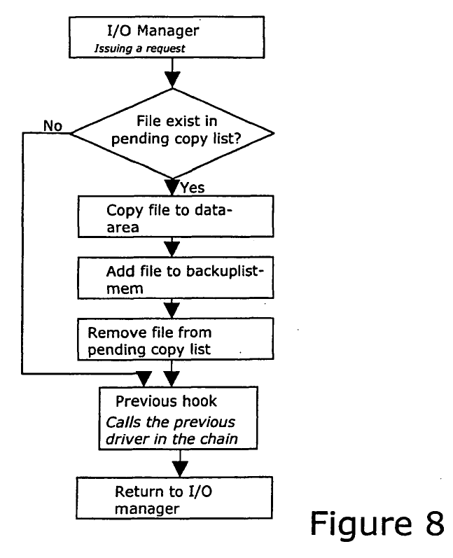

In FIG. 8, an embodiment of the logic for writing data to a file previously opened using open existing or create new file is presented.

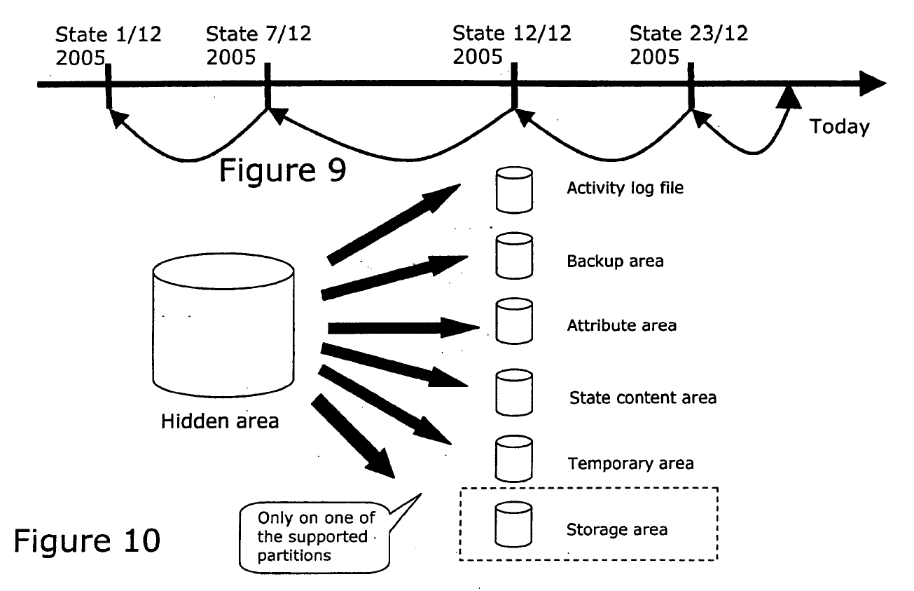

In FIG. 9, the process of restoring to a specific state using all states taken after that time in chronological order is presented.

In FIG. 10, an embodiment of the hidden area is presented.

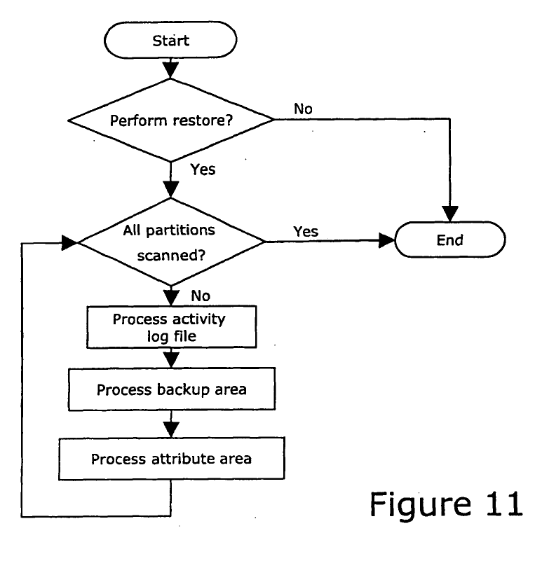

In FIG. 11, an embodiment of the restore process is presented.

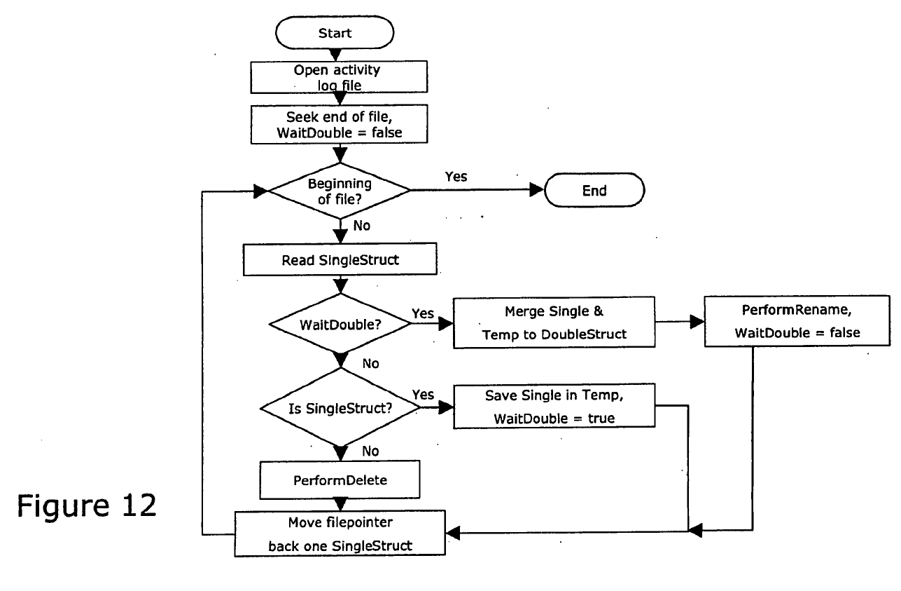

In FIG. 12, an embodiment of the activity log file processing is presented.

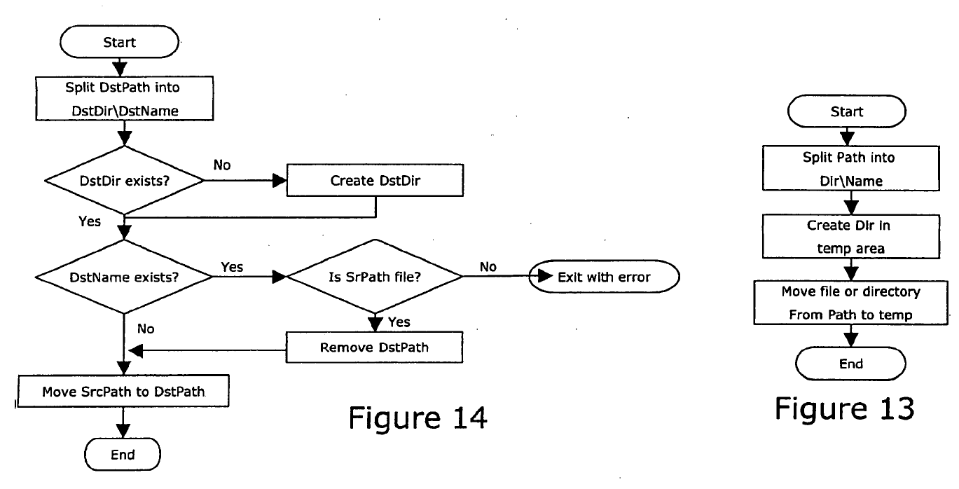

In FIG. 13, an embodiment of the logic for performing a delete operation in the restore process is presented.

In FIG. 14, an embodiment of the logic for performing a rename operation in the restore process is presented.

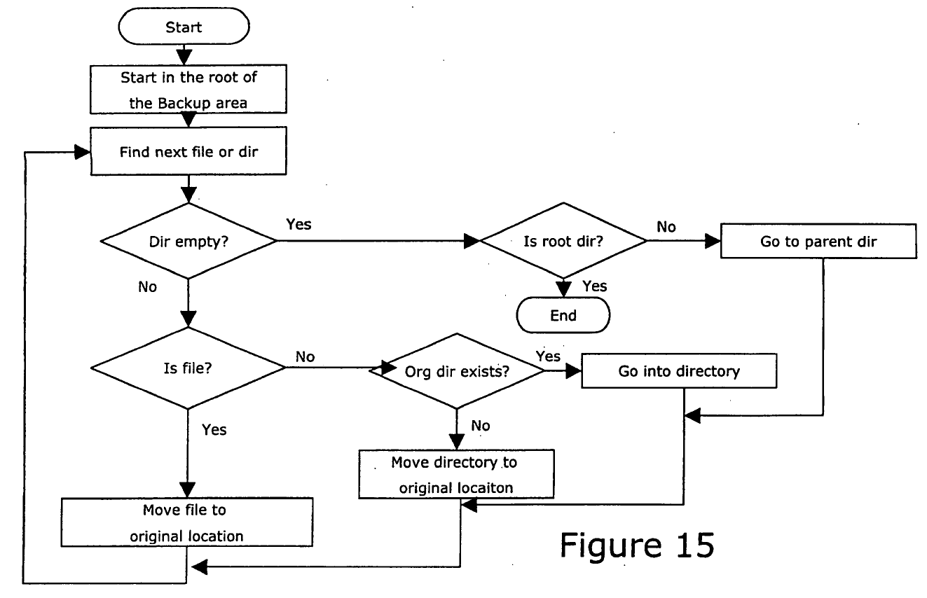

In FIG. 15, an embodiment of the backup area processing is presented.

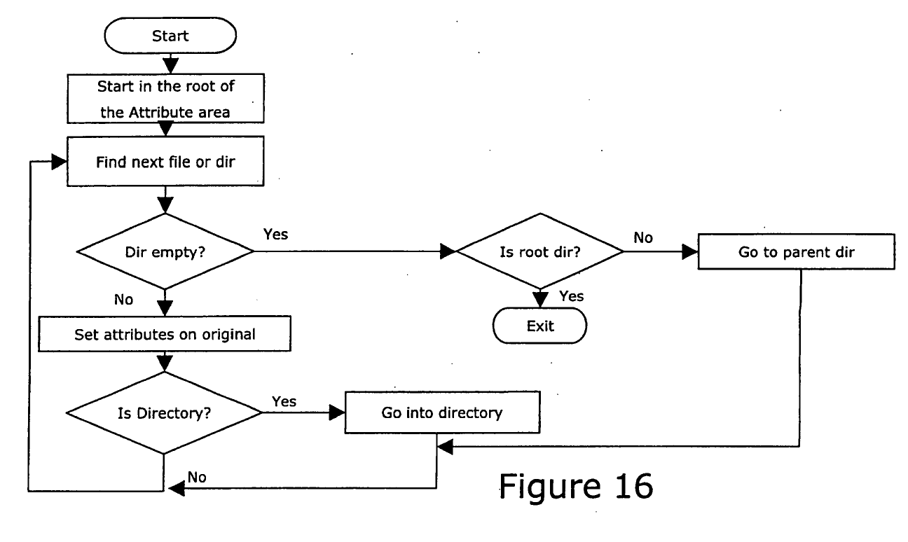

In FIG. 16, an embodiment of the attribute area processing is presented.

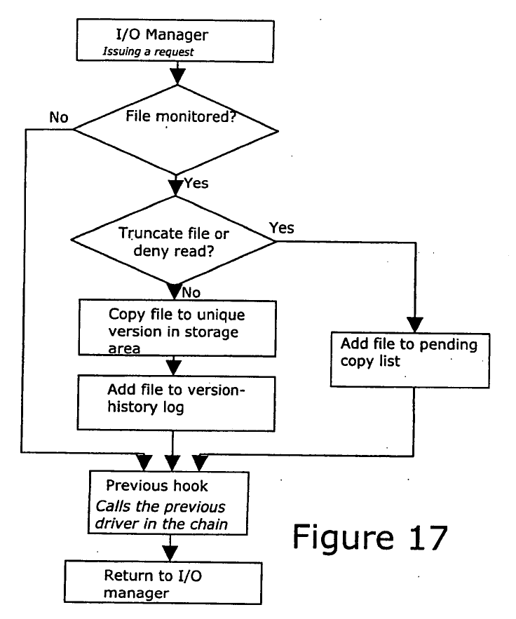

In FIG. 17, an embodiment of the logic for opening existing application oriented file (with or without truncation of file) is presented.

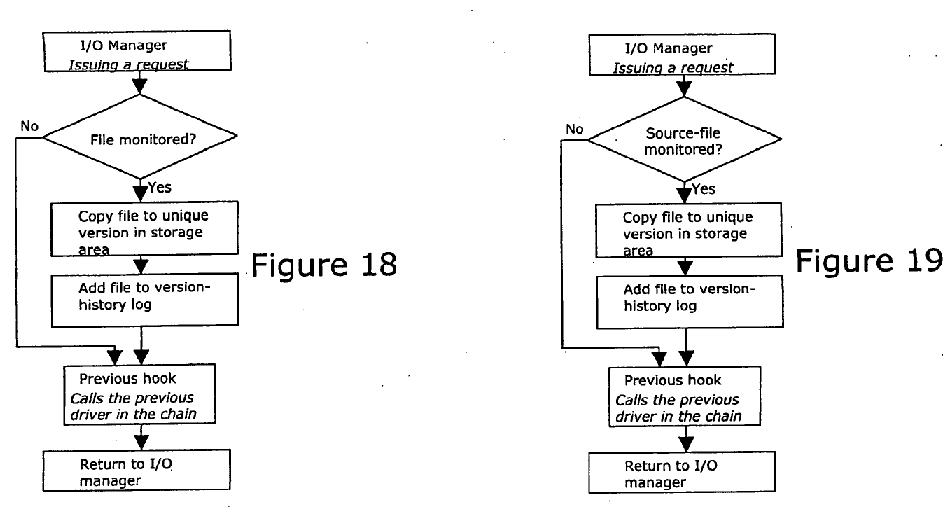

In FIG. 18, an embodiment of the logic for removing an existing application oriented file is presented.

In FIG. 19, an embodiment of the logic for renaming/moving an existing application oriented file is presented.

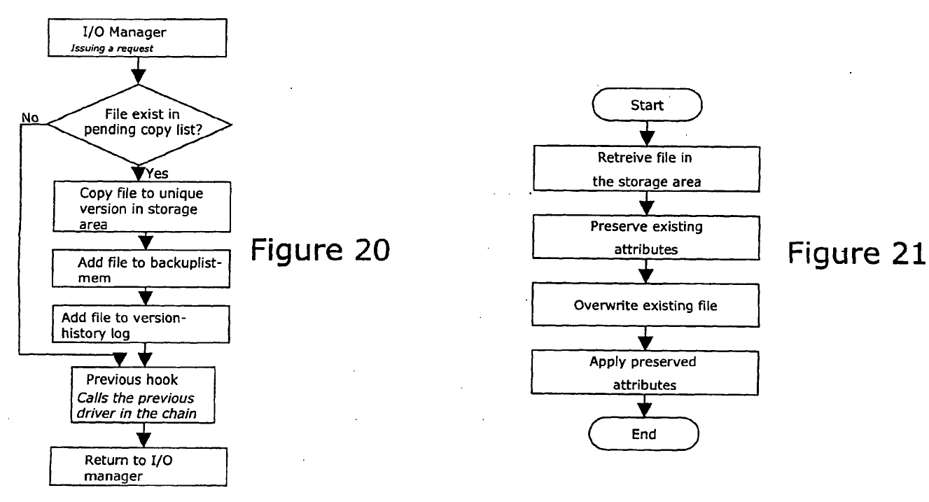

In FIG. 20, an embodiment of the logic for writing data to a application oriented file previously opened using opening existing or creating new file is presented.

In FIG. 21, an embodiment of the process of the application oriented file retrieval is presented.

### DESCRIPTIONS OF PREFERRED EMBODIMENTS

In FIG. 1, a schematic representation of the device for restoring at least one of files, directories and application-oriented files in a computer to a previous state is presented. The device comprises a processor, a memory, input/output means. The memory comprises a storage area, backup area, an attribute area, an activity log file, and a state content area. The backup area is arranged to comprise originals of the at least one of files and directories. The storage area being arranged to comprise 1) changes to application oriented files, leaving original application oriented files unaltered, and 2) copies of files and directories provided that there has been at least one alteration of the files and directories after the time of the previous state. The attribute area is arranged to comprise copies of attributes to files and directories, provided that there has been at least one alteration of the attributes to files and directories after the time of the previous state. The activity log file being arranged to comprise events related to the computer that have occurred after the time of the previous state. The state content area is arranged to comprise content in relation to files and directories at the time corresponding to the previous state.

Now turning to a specific embodiment and the operation of the invention, recoverable information is information that can easily be recreated. Examples are applications or system components. Typical for recoverable information is that it rarely changes over time. The present invention is designed to always offer an opportunity to be able to restore a predetermined state. A state, of a computer is created and changes to files and directories are from that moment monitored and logged. The user can at any time chose to restore a previous state.

In the invention a file system filter driver is used, a restore application and an area to preserve original files. The file system filter driver is a continuously running integrated part of the operating system and it is invisible to the user. The user can at any time return to a previous state by performing a restore operation. The restore operation may be performed during computer start up.

A hidden area is used for storing data required for restoring files and directory to their previous state. There is a hidden area on every partition monitored by the invention. A single storage media (for example a hard drive) can contain several partitions. The present implementation of the invention requires that file systems on all partitions to be used are based on a commonly used tree structure.

The following components are needed to restore files and directories to a predetermined state:
1. Backup area: Contains copies of original files and directories only if the files and directories have been modified since last state was set.
2. Attribute area: Contains empty files and directories with original attributes only if the files and directories attributes have been modified since last state was set.
3. Activity log file: The activity log file contains a list with chronological events. The two types of events are:
   Create: New files and directories created since the last state was set. Rename: Files and directories renamed since the last state was set.
4. State content area: Contains the backup area, attribute area and activity log file from previous states taken before the currently active state.

In addition to these four components located on permanent storage media, the file system filter driver also needs lists in volatile RAM memory to keep track of changes during runtime. Since these lists vanish at shutdown or restart they will be rebuilt using the first tree out of the four components described above as soon as the file system filter driver is started. A schematic overview of the system can be found in FIG. 2.

The filter file system filter driver needs to intercept all requests to the original file system filter driver that may modify data on the storage media. The requests of interest in commonly used operating systems can be divided into the following categories:
1. Open existing file for write (with or without truncation of file)
   Logic for this request is located in FIG. 3. The basic idea of this function is to copy the original file to the backup area before the file is altered. If it is a truncate request, the file needs to be copied before the original open operation; otherwise the copy can be delayed until the first write request for the file. The translated file is needed to keep track of the original file regardless of any rename operations that have been made.
2. Create a new file and directory
   Logic for this request is located in FIG. 4. This request adds the created files to the volatile create list and the permanent chronological activity log.
3. Remove existing file or directory
   Logic for this request is located in FIG. 5. If the file does not exist in any of the volatile lists, then the file is moved to the backup area. If the file exists in any of the two volatile lists, it is removed from both the volatile lists and the permanent activity log file. It is also required to remove the file from the translation table, since the original file ceases to exist.
4. Rename or move existing file or directory
   Logic for this request is located in FIG. 6. The rename request uses translation tables to be able to know the original file name regardless of previous rename operations. Apart from updating the translation table, the volatile create list is updated and an entry is added to the permanent activity log file.
5. Change attributes or security settings for existing file or directory
   Logic for this request is located in FIG. 7. Apart from data of a file, the attribute and security settings belonging to the file can also be modified. In order to be able to recreate the original attributes and security settings, an empty copy of the original file with the original attribute and security settings are created in the attribute area. There is also a volatile attribute list that keeps track of all files currently in the attribute part of the attribute area.
6. Write data to a file previously opened using open existing file or create new file
   Logic for this request is located in FIG. 8. The write request is only made on previously opened or created files. The only thing done here is checking whether the file has been flagged for copy by the open file function and copy the file to the backup area.

Thus, this invention does not require alteration of the file system requests. All requests are still directed to its original physical location.

Volatile memory lists (in RAM memory) and the permanent activity log file (on hard drive) are needed to be able to remember modifications made to files and directories on the hard drive. These lists are managed continuously whenever modifications are made according to the file system request logic described above. The file system filter driver uses volatile RAM memory, enabling to quickly keep track of performed operations. Since volatile RAM memory is at least 1000 times faster than hard drive storage, searching the lists are desirable to do in RAM memory. The restore application uses the chronological activity log file in the actual restore process.

A brief description of the volatile memory lists:
1. Create list: A list with all created files since the last state. This list needs to be updated upon a rename request in order to always contain current file names.
2. Backup list: A list with all files copied to the backup area. The file names in this list are the original files that have been modified since the last state.
3. Attribute list: A list with all file names in the attribute area with preserved original attributes and security settings. The file names in this list all have modified attributes since the last state.

Translation table: A two-dimensional lookup table to obtain the original file name (when the state was set) from the current file name. Since files and directories can be renamed more than once this list must be updated at every rename request.

According to an embodiment of the invention, it is possible to define files and directories as exceptions from the recoverable information protection. These exceptions are defined in a configuration file used by the file system filter driver. The file system filter driver detects whenever a request is made to an exception and passes the request through without logging data needed for a restore. It is also possible to define a specific application as an exception by adding it to the configuration file. The file system filter driver can detect which application that is issuing a request by comparing its executable file against the list of exception executable files in the configuration.

According to an embodiment, a state, is defining all files and directories on a partition at a specific time. By restoring to a state, all modifications made after the state has been set will be undone. To set a new state all that needs to be done is to delete all volatile lists, the activity log file and both the backup and the attribute area. When this is done, the file system filter driver will automatically use that state as the current state. It is also possible to have several independent states to choose between when restoring. This is possible by moving the activity log file, the backup area and the attribute area to a state content area. It is possible to restore a computer to any previous state set. However, states need to be processed as described in FIG. 9.

The role of the hidden area is to contain enough information to restore a computer to a previous state. The hidden area is not accessible for the user during normal use of the computer and it is also hidden from most parts of the operating system. The hidden area is located in the root directory of every supported partition. The area contains five sections as shown in FIG. 10.

The activity log contains information about files and directories that have been created and renamed. The activity log is empty from the beginning and as rename and create operations occur they are added to the activity log in chronological order. There are two types of log entries, single structures and double structures. A single structure represents a created file or directory and a double structure represents a file or directory rename. The double entry is twice the size of a single entry since more information is needed for a rename. However, the last part of a double structure is designed to match the layout of a single structure. This is done in order to traverse log entries reversed during a restore operation.

The single structure contains two members:
Path
Operation

The path contains the full path to the file or directory that has been created. The operation variable is a bit flag that can have one or more of the following values:
RESERVED (BIT 0-3), reserved for future use, is always zero
DOUBLE₁₃ STRUCT (BIT 4), indicates that this is a double structure and more information is needed to create a full double structure entry
RESERVED (BIT 5), reserved for future use, is always zero
DIR_FLAG (BIT 6), indicated if the path refers to a file or directory
DELETE_MARK (BIT 7), indicates if the log entry is marked as deleted. Log entries marked as deleted are ignored during a restore operation

If the directory \data\directory is created the corresponding single log entry structure will have the path set to \data\directory and the operation member will have the value DIR_FLAG. The double structure has three members:
Source path
Destination path
Operation

The source path is the original file name and the destination path is the new file name. The operation member is the same as for a single structure but with the bit DOUBLE_STRUCT set. If the file \old.txt is renamed to \new.txt the corresponding double log entry structure will have the source path set to \old.txt and the destination path set to \new.txt. The Operation member will have the value DOUBLE_STRUCT. The activity log file entries forms a list of created and renamed files and directories since the last state. The entries are contained in a single physical activity log file residing in the hidden area.

The backup area is a directory that contains parts of the information needed to restore the computer to a known state. The backup area contains all files that have been modified or removed since the last state. The backup area uses the same directory structure as the original directory structure with the exception that its root is the backup area. For example, if the file \program files\MyApp\Important.hlp is deleted the file will be moved to \<hidden area>\backup\program files\MyApp\Important.hlp. Preserving the directory structure is necessary to avoid file name collisions and it is also the fastest way to know where the original file is located. If the directory structure is not preserved some kind of map information is needed to know where a file in the backup area has its original location. Furthermore, if the directory structure is not preserved an algorithm to generate unique file names in the backup area is needed.

During everyday use of the computer more and more files will end up in the backup area. The size of the backup area is somewhat proportional to the number of files that have been modified or deleted since the last state.

The attribute area is a directory that contains information about the attributes of files and directories that have been changed since the last state. If the attributes of a file or directory is modified the original attributes will be preserved in the attribute area. The attribute area uses the same physical layout as the backup area. If for example the attribute of. the directory \Temp is changed the original attribute will be preserved in \<hidden area>\attribute\Temp. Attribute modifications on files will result in attribute preserved files with the file size 0 in the attribute area. The activity log file, the backup area and the attribute area together contain all information needed to restore the computer to the latest state.

When a new state is set the information contained in the activity log file, backup area and attribute area are moved to the state content area. This area makes it possible to revert back to any previous state.

A temporary area contains all files and directories that have been removed during a restore process. The reason for a file or a directory to be deleted during a restore process is that it has been modified or created after the last state. Information in the temporary area is used for undoing the last restore operation.

The purpose of the restore application is to restore the computer to a previous state. The restorer uses the information in the hidden area to accomplish its task. This includes processing the activity log file to undo rename and create operations, processing the backup area to restore modified or deleted files, and processing the attribute area to restore the original file attributes. The restore operation is performed as early as possible during the boot sequence of the computer. On all known and documented file systems this can be done before the operation system boots using a common boot sector loading mechanism. If the file system is not known, a restore is performed as soon as the drivers for this file system are loaded in the operating system boot process. The restore process can be activated either by a user command from inside the operating system or it can be activated early in the boot sequence by the user. The restore operation uses a bit flag to detect whether a restore was requested or not. If the bit flag is set the restore process is activated without asking the user. However, if the bit flag is not set the user can still initiate a restore during a defined time interval.

If the user does not wish to perform a restore the loading of the boot sequence continues as normal. However, if the user wishes to perform a restore the following occurs:

Every supported partition on all physical hard drives in the computer is scanned. On every partition the restorer checks whether there is something to restore or not. If there at least exist an activity log file, a backup directory or an attribute area, a restore is initiated.

The restorer processes the hidden area in a well-defined order:
1. Activity log file, renamed files or directories will be restored to their original locations and created files or directories will be removed.
2. Backup area, modified or deleted files will be restored.
3. Attribute area, attribute changes on files or directories will be restored.

Files that are removed during a restore are moved to the temporary area. This makes it possible to perform an undo operation after a restore. Since all operations either are a move operation or an attribute operation the restore process is extremely fast. It normally finishes in a couple of seconds. Moving a file is a lot faster than copying a file because a move operation only involves moving a file reference pointer. A copy operation involves duplicating both the file reference pointer and the data contained in the file, which makes it very slow compared to the move operation.

The process of restoring each of these areas will be explained in detail below. The restore process can be seen in FIG. 11.

When the restorer has finished its tasks it continues to load the operating system. If the restore was started using a boot sector loading mechanism, the original operating system boot sector is then loaded into memory and executed. Otherwise the operating system initialisation continues as normal.

The activity log file contains information about which files and directories that have been renamed and created. The activity log file contains one log entry for each operation. The entry list is a chronological history of every rename and create that have occurred since the last state. To revert the computer back to a previous state the activity log file needs to be processed backwards. The logic for the activity log file processing is located in FIG. 12.

Single structures represent file creations and the double structures represent rename or move operations. The first log entry read is the last one in the activity log file. The log entry is first read into a single structure. If the operation flag has the bit DOUBLE_STRUCT set we need to read the second half of the double structure before processing the rename operation. If the bit is not set the operation is a single structure and hence a file or directory deletion is to be performed. If a file or directory rename or deletion fails the entry will be marked with an OPERATION_FAILED mark. The activity log file processing is finished when all entries have been scanned.

The PerformDelete (Path) function shown in FIG. 13 works as follows. Instead of deleting the file or directory specified by Path it will be moved to the temporary area. Directory structures are preserved when files and directories are moved.

The PerformRename(SrcPath, DstPath) moves the file or directory specified by SrcPath to DstPath as seen in FIG. 14. The directory structure of DstPath is created if it does not already exist. If SrcPath points to a file, any existing file in DstPath will be removed before the actual move operation.

The backup area contains all original files that either have been modified or removed since the last state. The restorer is responsible for moving these files from the backup area to their original locations. The algorithm used is located in FIG. 15. The algorithm uses a depth first search and tries to move every file and directory. If the original directory already exists the search will continue in that directory. When all files and directories are processed the search will continue in the parent directory. The algorithm exits when all files and directories are processed in the root of the backup area. Trying to move a directory starting from the lowest level in the directory structure has the advantage that it can save a lot of subsequent move operations. Consider the case when a directory contains thousands of files. The directory and all of its files are removed during computer usage. During a restore the only operation performed will be one directory move. This design makes the restore process very fast.

The processing of the attribute area is the last step in the restore operation. The task of the restorer is to apply the attributes in the attribute area to the original files and directories. The processing of the attribute area is very similar to that of the backup area as can be seen in FIG. 16. The algorithm uses a depth first search function and applies the attribute on the original file and directories.

Unrecoverable information is information that is hard, and sometimes even impossible, to recreate. Examples of this are documents and presentations, i.e. application oriented files. Unrecoverable information usually changes over time and should therefore be continuously backed up. The invention tracks every change that is made to files that are defined as unrecoverable. The heart of the automatic versioning system is the combination of a file system filter driver and a storage area. The file system filter driver is responsible for detecting file changes and save these changes in the storage area. A previously saved or removed file. can be retrieved in two ways. One way is to right click the file and choose to list all available versions for that specific file. The other way is to use the rollback explorer that can browse all files currently in the storage area.

The file system filter driver is capable of monitoring both local files, and files residing on a network drive. The storage area can be located locally or on a network drive.

Each system component will be explained in detail below.

Designing a versioning file system filter driver is quite similar to the recoverable information driver. The basic idea is that files need to be backed up before they are modified.

The file system filter driver used for unrecoverable information is physically the same driver as for recoverable information although different parts of the code are used. A method that reads a user-defined configuration determines if a given file or directory should be handled as recoverable, unrecoverable or as an exception. Note that only files can be treated as unrecoverable information since a directory is only a container for files, with no associated data.

The change of attributes and security settings request are not monitored since it does not change the data contained in a file. File system requests monitored by the file system filter driver are:
1. Open existing file for write (with or without truncation of file)
   Logic for this request is located in FIG. 17. This function copies the original file to a unique file name in the storage area before the original request is performed. If the file is opened for truncation or with exclusive read access a copy must be performed at this point. If this is not the case a copy can be delayed until the first write request. Files are copied to the storage area and an entry containing additional file information is added to the storage area log file.
2. Remove an existing file
   Logic for this request is located in FIG. 18. This function copies the original file to a unique file name in the storage area before the original request is performed. An entry containing associated information on the file is also added to the storage area log file.
3. Rename or move existing file
   Logic for this request is located in FIG. 19. This function copies the original file to a unique file name in the storage area before the original request is performed. An entry containing additional file information is added to the storage area log file.
4. Write data to a file previously opened using open existing file or create new file
   Logic for this request is located in FIG. 20. The write request is made only on previously opened or created files. The only thing done here is checking whether the file has been flagged for copy by the open file function and if necessary copy the file to the storage area and add an entry to the storage area log file.

A new file version is created each time a file has changed. The number of copies can quickly increase and thus the occupied storage space of the storage area. Therefore the storage area is constantly monitored so that the occupied space is within a predefined limit. The oldest file is automatically deleted when the storage space of the storage area exceeds the predefined limit. If the deleted file did not occupy enough space, then more files are deleted using the same logic until enough space has been released.

The purpose of the storage area is to contain historic versions of files marked as unrecoverable. The storage area is not accessible for the user during normal use of the computer and is also hidden from most parts of the operating system. The storage area can be located either on the local computer or on a network location. Central storage of information protects the user from losing files when hardware errors occur on the workstation. Important to notice is that the storage area only exists on one partition. Each file in this area contains additional information in a log.

The storage area preserves directory structures on the 10 hard drives when storing file versions. If for example a file in \data is changed the original version will be saved in <storage area>\aa\data and if a file in \Documents is changed it will be saved in <storage area>\ba\documents. The aa and ba are mapping characters. used in the file system filter driver to differ from partitions. The mapping characters can have any combination from aa to zz.

Every file in the storage area contains a number. This number uniquely identifies a certain file version. The version number is appended at the end of a file name. For example, if the file summary.ppt is being backed up for the third time the name in the storage area will be summary.ppt_{—}3.

Storing files as they change requires free space on the hard drive. The user defines the hard drive space set aside for the system and the file system filter driver automatically manage the area by deleting the oldest versions when more space is required. Of course, a large storage area means a longer history buffer for each file.

Every directory in the storage area contains a log file.

This log file contains additional information about every file in the directory. A log entry contains the following members:
File name
Version
User
Application

The file name combined with the version number links the entry to a specific file. The user member contains information about which user that performed the change, and the application member contains information about which application the change was made with.

The invention offers two ways to retrieve old file versions. One way is to select properties for a file in a file browser. An additional property page, called the rollback sheet, will be shown to the user. This page contains the version history of the currently selected file. The user can select, preview and recover any file in the history list.

The other way is to use the rollback explorer. The rollback explorer is capable of browsing the storage area for unrecoverable files. The rollback explorer is useful when a file has been removed from its original location and thus makes the rollback sheet impossible to use.

The file retrieval algorithm is the same for both methods and is presented in FIG. 21. The algorithm first retrieves the file the user has selected and then copies it to a user-selected location. If a file already exists the attributes of the existing file will be preserved.

1. A device (1) for restoring at least one of files, directories and application oriented files in a computer to a previous state, the device comprising a processor (3), a memory (5), input/output means (7); the memory (5) comprising a storage area (9), backup area (11), an attribute area (13), an activity log file (15), and a state content area (17);
the backup area (11) being arranged to comprise originals of the at least one of files, directories and application oriented files;
the storage area (9) being arranged to comprise
changes to application oriented files, leaving original application oriented files unaltered;
copies of files and directories provided that there has been at least one alteration of the files and directories after the time of the previous state;
the attribute area (13) being arranged to comprise copies of attributes to files and directories, provided that there has been at least one alteration of the attributes to files and directories after the time of the previous state; and
the activity log file (15) being arranged to comprise events related to the computer that have occurred after the time of the previous state;
the state content area (17) being arranged to comprise content in relation to files and directories at the time corresponding to the previous state; the device (1) being configured for
receiving from a user, using the input/output means (7), an instruction to restore the computer to the previous state;
investigating at least one of:
the content of the backup area (11) and attribute area (13) for alterations; and
the content of the activity log file (15) for occurred events;
restoring the at least one of files, directories and application oriented files in the computer to the previous state by
processing at least one of
one or more of the events in the activity log file (15); and
one or more of the files in the backup area (11) and the attribute area (13), and then
restoring the state according to the content of the state content area (17).

2. Device according to claim 1, wherein the activity log file (15) is arranged for comprising at least two types of activities: new files/directories and renamed files/directories.

3. Device according to claim 1 wherein, the state content area (17) is arranged to comprise a number of states available for a user, using the input/output means (7), to select a state.

4. Device according to claim 1, wherein the processor (3) is further configured for:
moving the content of the backup area (9), the attribute area (13), the state content area (17), and the activity log file (15) to a history area.

5. Device according to claim 1, wherein the processor (3) is further configured for:
allowing a user to select and recreate one of a number of states of the at least one of files and directories.

6. Device, according to claim 1, wherein the processor (3) is further configured for:
creating a state of the computer, the creating having been initiated by one of the user, a system event, and according to a predetermined schedule.

7. Device according to claim 1, wherein the memory (5) is further configured for comprising a translation list keeping track of information in the backup area (11), the attribute area (13), and the activity log file (15).

8. Device according to claim 1, wherein the memory (5) comprising the translation list is constituted by the RAM memory.

9. Device according to claim 4, wherein the processor (3) is further configured for allowing a user to exclude at least one of files, directories and application oriented files from being processed by the device.
